(19) United States
(12) Patent Application Publication
(10) Pub. No.: US 2023/0078747 A1
(43) Pub. Date: Mar. 16, 2023

(54) ROLLABLE DISPLAY DEVICE

(71) Applicant: Samsung Display Co., LTD., Yongin-si (KR)

(72) Inventors: Jae Ho AHN, Asan-si (KR); Beom Jin KIM, Asan-si (KR); Tae Woong KIM, Seongnam-si (KR); Sang Jun LEE, Hwaseong-si (KR); Jin Hwan CHOI, Seoul (KR)

(73) Assignee: Samsung Display Co., LTD., Yongin-si (KR)

(21) Appl. No.: 17/859,594

(22) Filed: Jul. 7, 2022

(30) Foreign Application Priority Data
Sep. 16, 2021 (KR) 10-2021-0124014

(51) Int. Cl. G06F 1/16

(52) U.S. Cl. CPC G06F 1/1652

(57) ABSTRACT

An embodiment provides a display device including a first roller and a second roller spaced apart from each other, a rotation belt surrounding the first roller and the second roller; and a display panel including a portion disposed on the rotation belt, wherein the display panel is extended by being released from the rotation belt in a first direction.

### CROSS-REFERENCE TO RELATED APPLICATION(S)

This application claims priority to and benefits of Korean Patent Application No. 10-2021-0124014 under 35 U.S.C. § 119, filed in the Korean Intellectual Property Office on Sep. 16, 2021, the entire contents of which are incorporated herein by reference.

### BACKGROUND

### 1. Technical Field

The disclosure relates to a rollable display device.

### 2. Description of the Related Art

A display device may include, for example, a liquid crystal display (LCD), a plasma display panel (PDP), an organic light emitting diode device (OLED device), a field emission display (FED), and/or an electrophoretic display device.

In recent years, foldable display devices that can be folded or unfolded, and rollable display devices that can be rolled have been developed.

In case that a rollable display device is rolled, there may be problems in that some components of the display panel may be detached from each other, and cracks may occur in some of the components of the display device due to a stress applied.

It is necessary to minimize the stress applied to the display panel during operation in order to use the rollable display device over a long duration.

Further, as portability of the display device may be required, it is desirable to reduce a volume and thickness of the display device.

The above information disclosed in this Background section is only for enhancement of understanding of the background of the disclosure, and therefore, it may contain information that does not form the prior art that is already known in this country to a person of ordinary skill in the art.

### SUMMARY

Embodiments have been made in an effort to provide a display device capable of preventing a display panel from being damaged by a stress applied to the display panel by reducing the stress in case that the display device is rolled without increasing a thickness of the display device.

However, problems to be solved by the embodiments is not limited to the above-described problem, and can be variously extended within the scope of the technical spirit included in the embodiments.

An embodiment provides a display device that may include a first roller and a second roller spaced apart from each other, a rotation belt surrounding the first roller and the second roller, and a display panel including a portion disposed on the rotation belt, wherein the display panel may be extended by being released from the rotation belt in a first direction.

The first roller and the second roller may be spaced apart from each other in the first direction.

A distance between the first roller and the second roller may be constant.

The first roller and the second roller may rotate in a same direction.

The first roller and the second roller may be rotatable with respect to a rotation axis that may be parallel to a second direction perpendicular to the first direction.

A surface of the rotation belt that may be parallel to the first direction may be flat.

Groove portions or convex portions may be disposed on a surface of the first roller and a surface of the second roller, and a surface of the rotation belt may include convex parts inserted into groove portions of the first and second rollers, or groove parts into which the convex portions of the first and second rollers may be inserted.

A planar shape of the groove portions or the convex portions and a planar shape of the convex parts or the groove parts are a same shape.

An embodiment provides a display device that may include an accommodating portion including a rolling member, and a display panel that is accommodated in the accommodating portion while being wound around the rolling member of the accommodating portion and that extends from the accommodating portion in a first direction while being unwound from the rolling member. The rolling member may include a first roller and a second roller spaced apart from each other, and a rotation belt surrounding the first roller and the second roller, and the display panel may include a portion on the rotation belt in the accommodating portion.

The first roller and the second roller may be spaced apart from each other in the first direction.

A distance between the first roller and the second roller may be constant.

The first roller and the second roller may rotate in a same direction.

The first roller and the second roller may be rotatable with respect to a rotation axis that is parallel to a second direction perpendicular to the first direction.

A surface of the rotation belt that may be parallel to the first direction may be flat.

A width of the surface of the rotation belt parallel to the first direction may be greater than a thickness of the rotation belt measured in a direction perpendicular to the first direction.

Groove portions or convex portions may be disposed on a surface of the first roller and a surface of the second roller, and a surface of the rotation belt may include convex parts inserted into groove portions of the first and second rollers, or groove parts into which the convex portions of the first and second rollers may be inserted.

A planar shape of the groove portions or the convex portions and a planar shape of the convex parts or the groove parts may be a same shape.

The display panel may include a driving area to which driving circuits may be electrically connected, and the driving area may be disposed in the accommodating portion.

The display device may further include a handle portion facing the accommodating portion in the first direction.

The display panel may include a driving area to which driving circuits may be electrically connected, and the driving area may be disposed in the handle portion.

In accordance with the display device according to the embodiments, it may be possible to prevent a display panel from being damaged by a stress applied to the display panel by reducing the stress in case that the display device is rolled without increasing a thickness of the display device.

However, the effect of the embodiments is not limited to the above-described effect, and may be variously extended without departing from the spirit and scope of the embodiments.

### BRIEF DESCRIPTION OF THE DRAWINGS

FIG. 1 illustrates a schematic perspective view showing a rollable display device according to an embodiment.

FIG. 2 illustrates a schematic perspective view of a rolling member of a display device according to an embodiment.

FIG. 3 illustrates a schematic perspective view showing a rolling member and a display panel of a display device according to an embodiment.

FIG. 4 illustrates a schematic view of a surface of a roller of a rolling member of a display device according to an embodiment.

FIG. 5 illustrates a schematic view of a surface of a rotation belt of a rolling member of a display device according to an embodiment.

FIG. 6 illustrates a schematic top plan view of a display device according to an embodiment.

FIG. 7 illustrates a schematic top plan view of a display device according to an embodiment.

### DETAILED DESCRIPTION OF THE EMBODIMENTS

The disclosure will be described more fully hereinafter with reference to the accompanying drawings, in which embodiments of the disclosure are shown. As those skilled in the art would realize, the described embodiments may be modified in various different ways, all without departing from the spirit or scope of the disclosure.

To clearly describe the disclosure, parts that may be irrelevant to the description may be omitted, and like numerals refer to like or similar constituent elements throughout the specification.

The accompanying drawings are provided only in order to allow embodiments disclosed in the specification to be easily understood and are not to be interpreted as limiting the spirit disclosed in the specification, and it is to be understood that the disclosure includes all modifications, equivalents, and substitutions without departing from the scope and spirit of the disclosure.

Further, since sizes and thicknesses of constituent members shown in the accompanying drawings may be arbitrarily given for better understanding and ease of description, the disclosure is not limited to the illustrated sizes and thicknesses. In the drawings, the thicknesses of layers, films, panels, regions, areas, etc., may be exaggerated for clarity.

It will be understood that when an element such as a layer, film, region, or substrate is referred to as being “on” another element, it can be directly on the other element or intervening elements may also be present. In contrast, when an element is referred to as being “directly on” another element, there may be no intervening elements present. Further, in the specification, the word “on” or “above” means positioned on or below the object portion, and does not necessarily mean positioned on the upper side of the object portion based on a gravitational direction.

The terms “comprises,” “comprising,” “includes,” and/or “including,”, “has,” “have,” and/or “having,” and variations thereof when used in this specification, specify the presence of stated features, integers, steps, operations, elements, components, and/or groups thereof, but do not preclude the presence or addition of one or more other features, integers, steps, operations, elements, components, and/or groups thereof.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

In the specification and the claims, the phrase “at least one of” is intended to include the meaning of “at least one selected from the group of” for the purpose of its meaning and interpretation. For example, “at least one of A and B” may be understood to mean “A, B, or A and B.”

It will be understood that, although the terms first, second, etc., may be used herein to describe various elements, these elements should not be limited by these terms. These terms are only used to distinguish one element from another element. For example, a first element may be referred to as a second element, and similarly, a second element may be referred to as a first element without departing from the scope of the disclosure.

Further, in the specification, the phrase “in a plan view” means when an object portion is viewed from above, and the phrase “in a cross-sectional view” means when a cross-section taken by vertically cutting an object portion is viewed from the side.

In addition, in the specification, “connected” means that two or more components are not only directly connected, but two or more components are connected indirectly through other components, physically connected as well as being electrically connected, or it may have been referred to as different names depending on the location or function, but may mean integral.

The terms “face” and “facing” mean that a first element may directly or indirectly oppose a second element. In a case in which a third element intervenes between the first and second element, the first and second element may be understood as being indirectly opposed to one another, although still facing each other.

Unless otherwise defined, all terms (including technical and scientific terms) used herein have the same meaning as commonly understood by one of ordinary skill in the art to which the disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

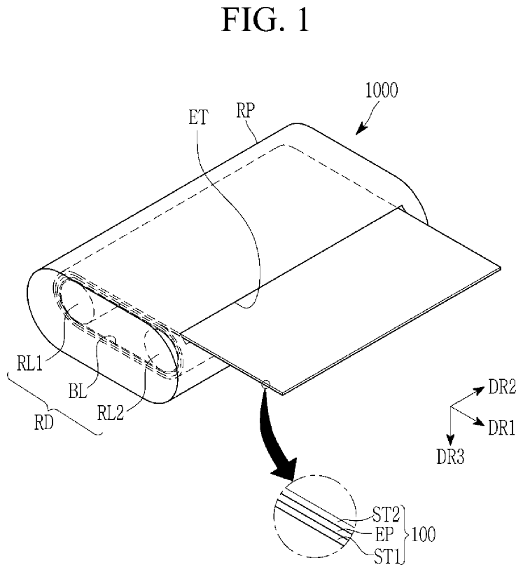

First, a display 1000 according to an embodiment will be described with reference to FIG. 1. FIG. 1 illustrates a schematic perspective view showing a rollable display device according to an embodiment.

Referring to FIG. 1, the display device 1000 according to an embodiment may include a display panel 100, an accommodating portion RP in which the display panel 100 can be accommodated, and a rolling member RD disposed in the accommodating portion RP, and an entrance ET formed in the accommodating portion RP.

The display panel 100 may be stored while being wound around the rolling member RD disposed in the accommodating portion RP, or may be extended along the first direction DR1 as a portion wound around the rolling member RD is unwound.

The display panel 100 may be accommodated in the accommodating portion RP through the entrance ET formed in the accommodating portion RP, or may extend outwardly from the accommodating portion RP.

The rolling member RD may include a first roller RL1 and a second roller RL2 that may be spaced apart along the first direction DR1, and a rotation belt BL surrounding the first roller RL1 and the second roller RL2.

The first roller RL1 and the second roller RL2 may be rotatable with a rotation axis parallel to the second direction DR2 that may be perpendicular to the first direction DR1, and the first roller RL1 and the second roller RL2 can rotate in a same direction.

For example, in case that the first roller RL1 and the second roller RL2 rotate in a counterclockwise direction, the display panel 100 may be accommodated in the accommodating portion RP while being wound around the rolling member RD, and in case that the first roller RL1 and the second roller RL2 rotate in a clockwise direction, the display panel 100 may be exposed from the accommodating portion RP while being released from the rolling member RD, to extend along the first direction DR1.

The display panel 100 may include an emission portion EP, a first sheet unit ST1 disposed below the emission portion EP, and a second sheet unit ST2 disposed above the emission portion EP.

The first sheet unit ST1 may include at least one functional sheet. For example, the first sheet unit ST1 may include at least one of a substrate on which the emission portion EP may be formed, a protective film disposed under the substrate, a cushion layer, a heat dissipation sheet, a light blocking sheet, a waterproof tape, and an electromagnetic shielding layer.

The second sheet unit ST2 may include at least one layer capable of protecting the emission portion EP, such as an anti-reflection layer or a window.

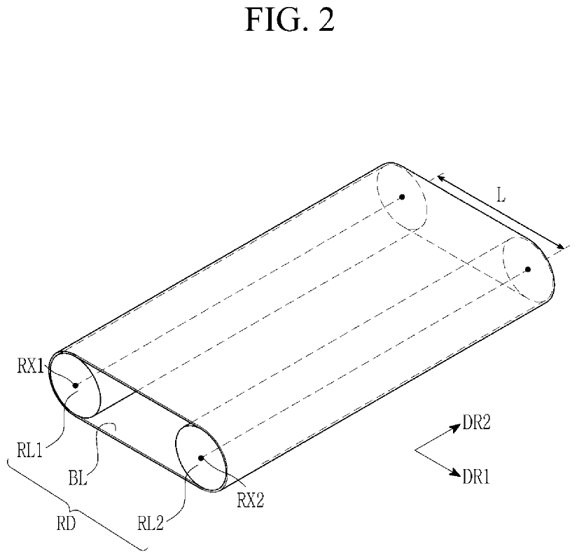

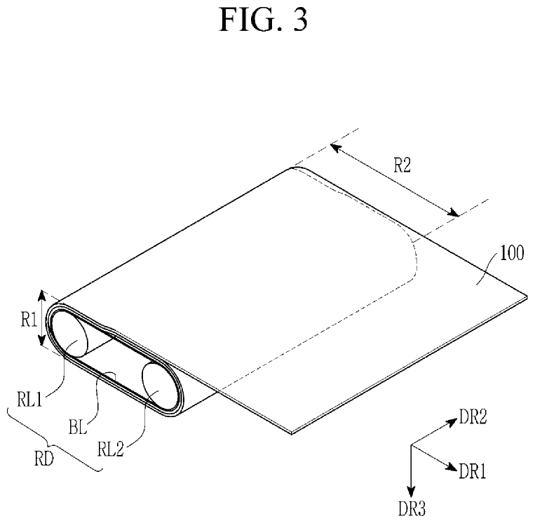

The rolling member RD of the display device 1000 according to an embodiment will be described with reference to FIG. 2 and FIG. 3 together with FIG. 1. FIG. 2 illustrates a schematic perspective view of a rolling member of a display device according to an embodiment, and FIG. 3 illustrates a schematic perspective view showing a rolling member and a display panel of a display device according to an embodiment.

Referring to FIG. 2, the rolling member RD may include a first roller RL1 and a second roller RL2 spaced apart from each other in a first direction DR1.

The first roller RL1 may be rotatable with a first rotation axis Rx1 parallel to the second direction DR2 perpendicular to the first direction DR1, and the second roller RL2 may be rotatable with a second rotation axis Rx2 parallel to the second direction DR2.

The first roller RL1 and the second roller RL2 may rotate in a same direction, and for example, the first roller RL1 and the second roller RL2 may rotate in a clockwise direction or in a counterclockwise direction.

The first roller RL1 and the second roller RL2 may have a same diameter, and a distance L between the first roller RL1 and the second roller RL2 may be constant without changing the first roller RL1 and the second roller RL2.

The rotation belt BL of the rolling member RD may simultaneously surround the first roller RL1 and the second roller RL2. The first roller RL1 and the second roller RL2 may be covered by the rotation belt BL except for opposite ends thereof disposed along the second direction DR2.

The rotating belt BL may rotate together depending on rotation directions of the first roller RL1 and the second roller RL2. For example, in case that the first roller RL1 and the second roller RL2 rotate clockwise, the rotating belt BL may also rotate clockwise, and in case that the first roller RL1 and the second roller RL2 rotate in the counterclockwise direction, the rotating belt BL may also rotate in the counterclockwise direction.

Referring to FIG. 3, the display panel 100 of the display device 1000 may have a state that may be wound around the rolling member RD, or a wound portion of the rolling member RD may extend in the first direction DR1.

As described above, the rolling member RD may include the first roller RL1 and the second roller RL2 spaced apart along the first direction DR1, and the rotation belt BL surrounding the first roller RL1 and the second roller RL2, and thus a width of the rotation belt BL measured in the direction parallel to the first direction DR1 of the rolling member RD may be at least twice as large as a thickness of the rotation belt BL measured in a direction parallel to the third direction DR3 that may be perpendicular to the first direction DR1 and the second direction DR2.

Accordingly, a first region R1 of the rolling member RD parallel to the third direction DR3 may be a curved region like edges of the first roller RL1 and the second roller RL2, but a second region R2 of the rolling member RD parallel to the first direction DR1 may be an upper region or a lower region of the rolling member RD along a direction perpendicular to the third direction DR3, and the second region R2 of the rolling member RD may have a flat plane.

The rolling member RD of the display device 1000 according to an embodiment may include the first roller RL1 and the second roller RL2 that may be spaced apart along the first direction DR1, and the rotation belt BL surrounding the first roller RL1 and the second roller RL2 together, so as to increase an area of an outer surface of the rolling member RD while reducing diameters of the first roller RL1 and the second roller RL2, thereby reducing a thickness of the display device 1000 measured in a direction parallel to the third direction DR3.

The second region R2, which may be the upper region or the lower region of the rolling member RD, may have the flat plane, and thus in case that the display panel 100 is extended along the first direction DR1 while being wound around the rolling member RD or unwinding from the rolling member RD, the display panel 100 may maintain a flat state. Accordingly, a stress applied to the display panel 100 in case that the display panel 100 is rolled or unrolled may be relieved, and damage to the display panel 100 that may occur due to stress applied to the display panel 100 in case that the display panel 100 is rolled or unrolled may be reduced.

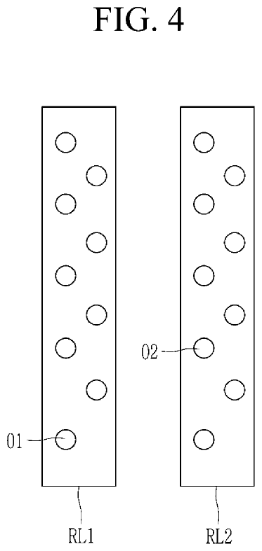

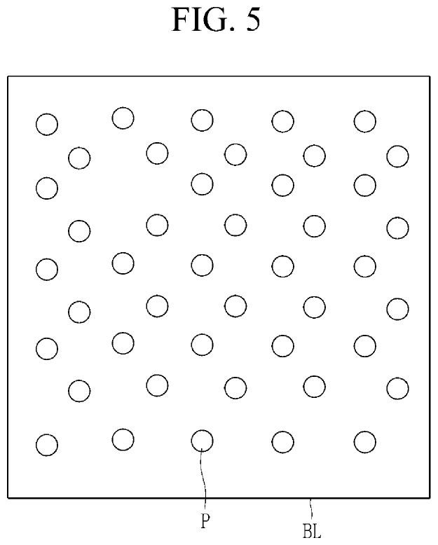

The rolling member RD of the display device 1000 according to an embodiment will be described with reference to FIG. 4 and FIG. 5. FIG. 4 illustrates a schematic view of a surface of a roller of a rolling member of a display device according to an embodiment, and FIG. 5 illustrates a schematic view of a surface of a rotation belt of a rolling member of a display device according to an embodiment. FIG. 5 illustrates an inner surface that may be in contact with the first roller RL1 and the second roller RL2 among surfaces of the rotation belt BL of the rolling member RD of the display device 1000 according to an embodiment.

Referring to FIG. 4, first groove portions O1 may be formed on a surface of the first roller RL1 of the rolling member RD of the display device 1000 according to an embodiment, and second groove portions O2 may be formed on a surface of the second roller RL2.

Referring to FIG. 5, convex portions P may be formed on the inner surface of the rotation belt BL of the rolling member RD of the display device 1000 according to an embodiment.

A planar shape and size of the first groove portions O1 and the second groove portions O2 formed on the surfaces of the first roller RL1 and the second roller RL2 of the rolling member RD may be determined by the rolling member RD may be the same as those of the convex portions P formed on the inner surface of the rotation belt BL.

The convex portions P formed on the inner surface of the rotating belt BL may be inserted into the first groove portions O1 and the second groove portions O2 formed on the surfaces of the first roller RL1 and the second roller RL2.

In case that the rotation belt BL of the rolling member RD surrounds the surfaces of the first roller RL1 and the second roller RL2 of the rolling member RD, the first groove portions O1 and the second groove portions O2 formed on the surfaces of the first roller RL1 and the second roller RL2 of the rolling member RD and the convex portions P formed on the inner surface of the rotation belt BL of the rolling member RD may be coupled to each other, thereby strengthening the coupling between the first roller RL1 and the second roller RL2 of the rolling member RD and the rotating belt BL of the rolling member RD. In case that the rotation belt BL of the rolling member RD is rotated depending on rotation of the first roller RL1 and the second roller RL2 of the rolling member RD, the rotation belt BL of the rolling member RD may also be accurately rotated depending on the rotation of the first roller RL1 and the second roller RL2 of the rolling member RD without sliding.

Accordingly, a coupling force and torque of the rolling member RD of the display device 1000 according to an embodiment may be increased.

Unlike as described above, in accordance with the display device according to another embodiment, the first convex portions O1 and the second convex portions O2 may be formed on the surfaces of the first roller RL1 and the second roller RL2 of the rolling member RD, and the groove portions P into which the first convex portions O1 and the second convex portions O2 can be inserted may be formed on the inner surface of the rotation belt BL of the rolling member RD.

According to an embodiment shown in FIG. 4 and FIG. 5, the first groove portions O1 and the second groove portions O2 formed on the surfaces of the first roller RL1 and the second roller RL2 of the rolling member RD and the convex portions P formed on the inner surface of the rotation belt BL of the rolling member RD have a circular planar shape, but the disclosure is not limited thereto, and they may have an elliptical planar shape or various polygonal planar shapes.

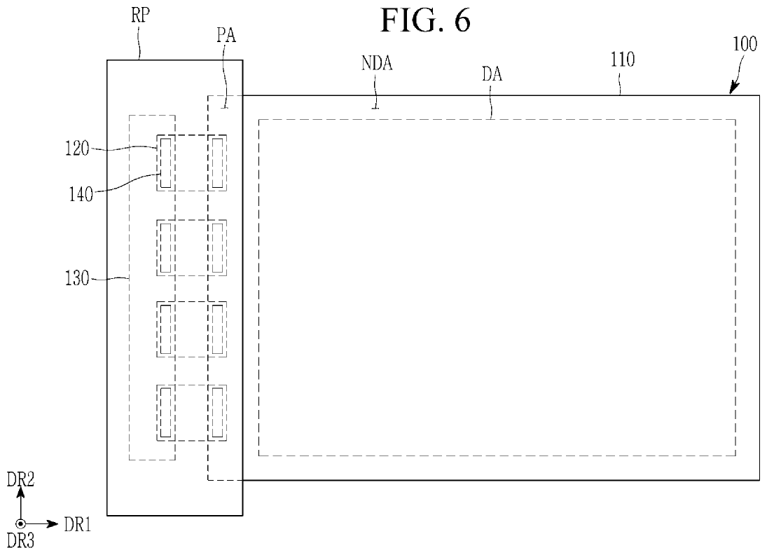

The display panel 100 of the display device 1000 according to an embodiment will be described with reference to FIG. 6. FIG. 6 illustrates a schematic top plan view of a display device according to an embodiment.

Referring to FIG. 6, the display panel 100 of the display device 1000 according to an embodiment may include a display area DA in which pixels may be formed to display an image, and a non-display area NDA disposed around the display area DA.

The non-display area NDA of the display panel 100 may include a driving area PA, and the driving area PA of the display panel 100 may include driving circuit units 130 through connectors 120.

The connectors 120 may be electrically connected to the driving area PA of the display panel 100 and the driving circuit units 130 by a conductive adhesive film 140.

The connectors 120 may include a film having flexibility, may be, e.g., a flexible printed circuit board (FPCB), and the conductive adhesive film 140 may be an anisotropic conductive film (ACF).

A driving circuit may be mounted in each of the driving circuit units 130.

The driving area PA, the connectors 120, and the driving circuit units 130 of the display panel 100 may be disposed in the accommodation portion RP.

As such, as the driving area PA, the connectors 120, and the driving circuit units 130 of the display panel 100 may be disposed in the accommodating portion RP, there may be no need for a separate structure for installing the driving area PA, the connectors 120, and the driving circuit units 130 of the display panel 100, and thus a volume of the display device 1000 may be reduced.

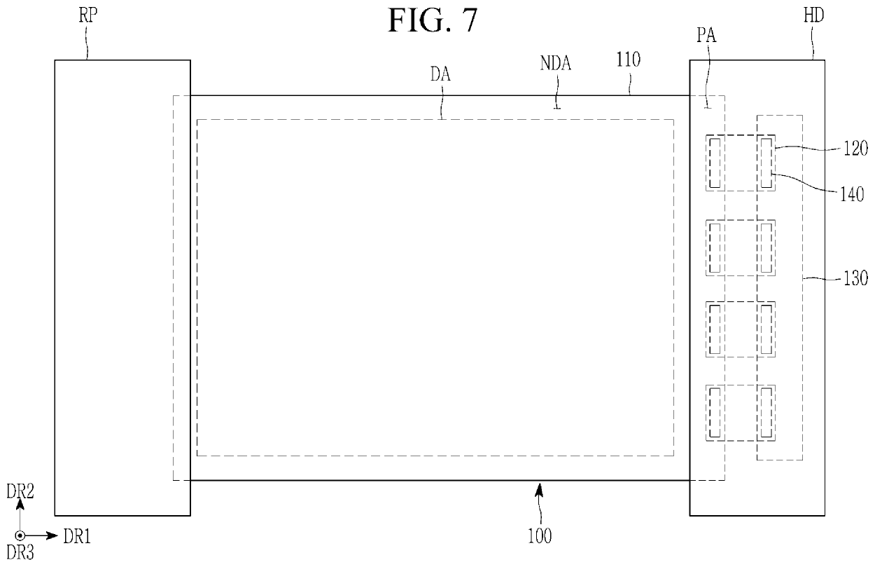

The display panel 100 of the display device 1000 according to an embodiment will be described with reference to FIG. 7. FIG. 7 illustrates a schematic top plan view of a display device according to an embodiment.

Referring to FIG. 7, the display panel 100 of the display device 1000 according to an embodiment may include a display area DA in which pixels may be formed to display an image, and a non-display area NDA disposed around the display area DA, and may further include a handle portion HD capable of pulling the display panel 100.

The driving area PA, the connectors 120, and the driving circuit units 130 of the display panel 100 may be accommodated in the handle portion HD. Accordingly, there may be no need for a separate structure for installing the driving area PA, the connectors 120, and the driving circuit units 130 of the display panel 100, and thus a volume of the display device 1000 may be reduced.

As described above, the rolling member RD of the display device 1000 according to an embodiment may include the first roller RL1 and the second roller RL2 that may be spaced apart along the first direction DR1, and the rotation belt BL surrounding the first roller RL1 and the second roller RL2 together, so as to increase an area of an outer surface of the rolling member RD while reducing diameters of the first roller RL1 and the second roller RL2, thereby reducing a thickness of the display device 1000 measured in a direction parallel to the third direction DR3.

The second region R2, which may be the upper region or the lower region of the rolling member RD, may have the flat plane, and thus in case that the display panel 100 may be extended along the first direction DR1 while being wound around the rolling member RD or unwinding from the rolling member RD, the display panel 100 may maintain a flat state. Accordingly, a stress applied to the display panel 100 in case that the display panel 100 is rolled or unrolled may be relieved, and damage to the display panel 100 that may occur due to stress applied to the display panel 100 in case that the display panel 100 is rolled or unrolled may be reduced.

In case that the rotation belt BL of the rolling member RD surrounds the surfaces of the first roller RL1 and the second roller RL2 of the rolling member RD, the first groove portions O1 and the second groove portions O2 formed on the surfaces of the first roller RL1 and the second roller RL2 of the rolling member RD and the convex portions P formed on the inner surface of the rotation belt BL of the rolling member RD may be coupled to each other, thereby strengthening the coupling between the first roller RL1 and the second roller RL2 of the rolling member RD and the rotating belt BL of the rolling member RD, and thus in case that the rotation belt BL of the rolling member RD is rotated depending on rotation of the first roller RL1 and the second roller RL2 of the rolling member RD, the rotation belt BL of the rolling member RD may also be accurately rotated depending on the rotation of the first roller RL1 and the second roller RL2 of the rolling member RD without sliding.

As the driving area PA, the connectors 120, and the driving circuit units 130 of the display panel 100 may be disposed in the accommodating portion RP or handle portion HD, there may be no need for a separate structure for installing the driving area PA, the connectors 120, and the driving circuit units 130 of the display panel 100, and thus a volume of the display device 1000 may be reduced.

While this disclosure has been described in connection with what is considered to be practical embodiments, it is to be understood that the disclosure is not limited to the disclosed embodiments, but, on the contrary, is intended to cover various modifications and equivalent arrangements included within the spirit and scope of the disclosure.

What is claimed is:

1. A display device comprising:
a first roller and a second roller spaced apart from each other;
a rotation belt surrounding the first roller and the second roller; and
a display panel including a portion disposed on the rotation belt,
wherein the display panel is extended by being released from the rotation belt in a first direction.

2. The display device of claim 1, wherein the first roller and the second roller are spaced apart from each other in the first direction.

3. The display device of claim 2, wherein a distance between the first roller and the second roller is constant.

4. The display device of claim 3, wherein the first roller and the second roller rotate in a same direction.

5. The display device of claim 4, wherein the first roller and the second roller are rotatable with respect to a rotation axis that is parallel to a second direction perpendicular to the first direction.

6. The display device of claim 1, wherein a surface of the rotation belt that is parallel to the first direction is flat.

7. The display device of claim 1, wherein
groove portions or convex portions are disposed on a surface of the first roller and a surface of the second roller, and
a surface of the rotation belt includes:
convex parts inserted into the groove portions of the first and second rollers; or
groove parts into which the convex portions of the first and second rollers are inserted.

8. The display device of claim 7, wherein a planar shape of the groove portions or the convex portions and a planar shape of the convex parts or the groove parts are a same shape.

9. A display device comprising:
an accommodating portion including a rolling member; and
a display panel that is accommodated in the accommodating portion while being wound around the rolling member of the accommodating portion and that extends from the accommodating portion in a first direction while being unwound from the rolling member, wherein
the rolling member includes:
a first roller and a second roller spaced apart from each other; and
a rotation belt surrounding the first roller and the second roller, and the display panel includes a portion on the rotation belt in the accommodating portion.

10. The display device of claim 9, wherein the first roller and the second roller are spaced apart from each other in the first direction.

11. The display device of claim 10, wherein a distance between the first roller and the second roller is constant.

12. The display device of claim 11, wherein the first roller and the second roller rotate in a same direction.

13. The display device of claim 12, wherein the first roller and the second roller are rotatable with respect to a rotation axis that is parallel to a second direction perpendicular to the first direction.

14. The display device of claim 9, wherein a surface of the rotation belt that is parallel to the first direction is flat.

15. The display device of claim 14, wherein a width of the surface of the rotation belt parallel to the first direction is greater than a thickness of the rotation belt measured in a direction perpendicular to the first direction.

16. The display device of claim 9, wherein
groove portions or convex portions are disposed on a surface of the first roller and a surface of the second roller, and
a surface of the rotation belt includes:
convex parts inserted into the groove portions of the first and second rollers; or
groove parts into which the convex portions of the first and second rollers are inserted.

17. The display device of claim 16, wherein a planar shape of the groove portions or the convex portions and a planar shape of the convex parts or the groove parts are a same shape.

18. The display device of claim 9, wherein
the display panel includes a driving area to which driving circuits are electrically connected, and
the driving area is disposed in the accommodating portion.

19. The display device of claim 9, further comprising:
a handle portion facing the accommodating portion in the first direction.

20. The display device of claim 19, wherein
the display panel includes a driving area to which driving circuits are electrically connected, and
the driving area is disposed in the handle portion.
